(19) United States
(12) Patent Application Publication
(10) Pub. No.: US 2025/0104312 A1
(43) Pub. Date: Mar. 27, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YASUKO KATO, Kanagawa (JP)

(21) Appl. No.: 18/884,349

(22) Filed: Sep. 13, 2024

(30) Foreign Application Priority Data
Sep. 22, 2023 (JP) 2023-158109

(51) Int. Cl. G06T 11/60; G06F 3/12; G06T 3/40; G06T 5/50; G06T 7/40

(52) U.S. Cl. CPC G06T 11/60; G06F 3/1243; G06T 3/40; G06T 5/50; G06T 7/40; G06T 2207/20221

(57) ABSTRACT

An information processing apparatus includes an obtainment unit configured to obtain a seamless texture that is an image object in a predetermined size unit, an adjustment unit configured to adjust the size of the seamless texture so that the seamless texture is continuous between an end part of a predetermined disposition region of image data as a printing target and an end part of an adjacent region that is adjacent to the end part in a case where the seamless texture is arranged side by side in the disposition region, and a disposition unit configured to dispose the seamless texture adjusted by the adjustment unit side by side in the disposition region.

### BACKGROUND OF THE INVENTION

### Field of the Invention

The present disclosure relates to an information processing apparatus, an information processing method, and a storage medium.

### Description of the Related Art

There is a method of arranging image data of a plurality of posters, flyers, or the like to produce image data of one poster, flyer, or the like of a larger size. However, seams between adjacent image data are noticeable in some cases.

Patent Document 1 (Japanese Patent Laid-Open No. 2008-114586) is disclosed as a technology of connecting printed materials to appear as one large posted material. According to the disclosure of Patent Document 1, one large poster image is divided into a plurality of image sections, each image section is printed on an independent sheet, and printed materials are connected to produce a poster by using a small-sized printer. In this case, seams between the printed materials are continuous as in the original poster image.

However, the technology of Patent Document 1 does not consider seams in a case where a plurality of units of connected printed materials are posted side by side.

Thus, further improvement of convenience in a case where a plurality of pieces of image data are arranged to produce image data has been desired.

### SUMMARY OF THE INVENTION

An information processing apparatus of the present disclosure includes an obtainment unit configured to obtain a seamless texture that is an image object in a predetermined size unit, an adjustment unit configured to adjust the size of the seamless texture so that the seamless texture is continuous between an end part of a predetermined disposition region of image data as a printing target and an end part of an adjacent region that is adjacent to the end part in a case where the seamless texture is arranged side by side in the disposition region, and a disposition unit configured to dispose the seamless texture adjusted by the adjustment unit side by side in the disposition region.

Further features of the present invention will become apparent from the following description of exemplary embodiments with reference to the attached drawings.

### BRIEF DESCRIPTION OF THE DRAWINGS

FIG. 1 is a diagram illustrating the configuration of a system including an information processing apparatus;

FIG. 2 is a diagram illustrating a functional configuration of a printed material production application;

FIGS. 3A and 3B are diagrams illustrating an example of an edit screen of the printed material production application;

FIGS. 4A and 4B are flowcharts illustrating the process of seamless texture tiling processing;

FIG. 5 is a diagram illustrating an example of an edit screen of the printed material production application in a second embodiment;

FIG. 6 is a diagram showing the relationship of FIGS. 6A and 6B;

FIG. 6A is a flowchart illustrating the process of seamless texture tiling processing in the second embodiment;

FIG. 6B is a flowchart illustrating the process of processing following FIG. 6A;

FIGS. 7A to 7E are diagrams illustrating an example of a gold-silver texture synthesis method;

FIGS. 8A and 8B are diagrams illustrating an example of an illumination pattern generation method;

FIG. 9 is a diagram illustrating an example of an edit screen of the printed material production application in a third embodiment;

FIG. 10 is a flowchart illustrating the process of seamless texture tiling processing in the third embodiment;

FIG. 11 is a diagram showing the relationship of FIGS. 11A and 11B;

FIG. 11A is a flowchart illustrating the process of processing following FIG. 10;

FIG. 11B is a flowchart illustrating the process of processing following FIG. 11A; and

FIGS. 12A and 12B are diagrams for description of illumination pattern cutout.

### DESCRIPTION OF THE EMBODIMENTS

Preferable embodiments of the present disclosure will be described below in detail with reference to the accompanying drawings. The embodiments described below do not limit the present disclosure according to the claims, and not all combinations of features described in the embodiments are necessarily essential for the present disclosure.

### First Embodiment

A method of using a seamless texture (or texture) is available as a technology of making seams of image data unnoticeable. The seamless texture is an image object that has a unit size and is fabricated so that seams are noticeable in a case where the seamless texture is arranged (tiled) side by side. For example, a background image with unnoticeable seams can be produced by arranging the same seamless texture side by side without gaps in a background region.

A first embodiment describes an example in which a poster printing image is produced by using a printed material production application that is a Web application. The first embodiment also describes, as an example, a case where the seamless texture is used as a background for the entire poster and the posters are horizontally posted.

### (Information Processing System)

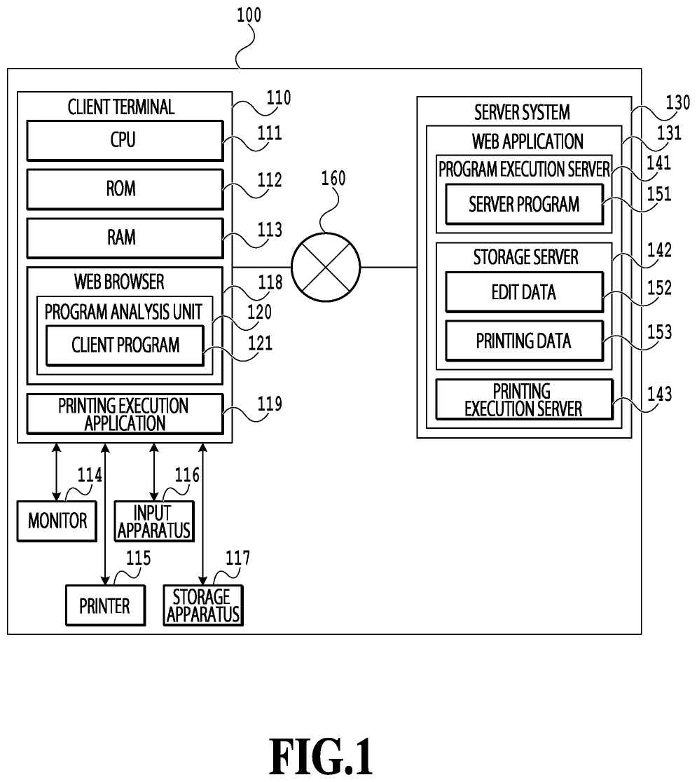

FIG. 1 is a diagram illustrating the configuration of an information processing system 100 including an information processing apparatus according to the first embodiment of the present disclosure. As illustrated in FIG. 1, the information processing system 100 is configured with a server system 130 and a client terminal 110 connected to perform communication there between through a network 160. Note that a communication scheme used for connection between apparatuses in the information processing system illustrated in FIG. 1 is, for example, communication standards of IEEE 802.11 series (Wi-Fi) and Bluetooth (including Bluetooth Classic, Bluetooth Low Energy (BLE), and the like). Note that the apparatuses in the information processing system of the present embodiment may be directly connected to each other, or communication among the apparatuses may be executed by the Internet communication through a wireless LAN router. Moreover, the apparatuses may communicate each other by mobile communication (including 3G, 4G, and 5G).

The server system 130 performs server processing on a Web application 131. As a specific example, the server system 130 includes a program execution server 141, a storage server 142, a printing execution server 143, and the like. The program execution server 141, the storage server 142, and the printing execution server 143 may be implemented by physically separated computers or may be implemented by one computer. A computer includes a CPU, a ROM, a RAM, a communication unit, a storage unit, and the like.

The program execution server 141 executes a server program 151 as a computer program that operates in the server system 130. The server program 151 is stored in the ROM or storage unit of the program execution server 141. The CPU of the program execution server 141 calls a computer program stored in the ROM or the storage unit, loads the computer program onto the RAM, and executes the computer program. The server program 151 has a function to control, for example, transmission-reception of processing requests, responses, and data between each server and the client terminal 110.

The storage server 142 stores various kinds of data such as image files and edit data 152 used by the Web application 131 and printing data 153 of a produced printing image.

The printing execution server 143 transmits the printing data 153 to a printing execution application 119 of the client terminal 110 to causes a printer 115 to execute printing processing.

The client terminal 110 is constituted by, for example, a computer terminal such as a personal computer or a smartphone and used by a user who produces a printed material such as a poster. The client terminal 110 includes a CPU 111, a ROM 112, a RAM 113, and the like. The client terminal 110 also includes a monitor 114, a printer (printing apparatus) 115, an input apparatus 116, a storage apparatus 117, and an input-output interface (not illustrated) for connection to the network 160 such as the Internet. The printer 115 is an image processing apparatus including a printing apparatus having a printing function to print information onto a printing medium by using a printing material. Alternatively, the printer 115 may be, for example, an apparatus further including a reading apparatus that reads an image on a document and functions as a copier, or may be a multi-function peripheral (MFP) additionally having other functions.

The CPU 111 is a central processing unit and controls the entire client terminal 110 by calling a computer program stored in the storage apparatus 117, the ROM 112, or the RAM 113, loading the computer program onto the RAM 113, and executing the computer program.

The CPU 111 of the client terminal 110 executes a Web browser 118, the printing execution application 119, and any other computer program stored in the ROM 112 and the RAM 113. The CPU 111 performs calculation and fabrication (processing) of input data in accordance with a computer program and outputs results. In addition, the CPU 111 controls each apparatus such as the printer 115 connected to the client terminal 110. Accordingly, functions of the client terminal 110 on the Web application 131 are implemented.

The ROM 112 is a read-only memory and stores computer programs to be executed by the CPU 111. The RAM 113 is a random access memory and used as a work memory of the CPU 111. The RAM 113 may be a non-transitory memory. In this case, the RAM 113 can store various computer programs.

The Web browser 118 is a computer program for implementing functions such as browsing of Web sites on the Internet and execution of the Web application 131 at the client terminal 110. In a case where executing the Web application 131, the Web browser 118 receives a client program 121 from the server system 130 and interprets the received client program 121 by a program analysis unit 120.

The program analysis unit 120 interprets a script language such as HTML or JavaScript and executes a computer program. The printing execution application 119 is a computer program for transmitting the printing data 153 produced by the Web application 131 to the printer 115 and executing printing. The printer 115 may be directly connected to the client terminal 110 or may be connected through a network such as a LAN.

Note that the apparatus configuration of a computer used as the client terminal 110 and the servers 141, 142, and 143 is exemplary and may include any other configuration for implementing various kinds of functions as appropriate.

In a case where image data is produced by using the above-described seamless texture and a plurality of printed materials on which the image data is printed are arranged, the texture is not continuous between end parts of the image data with noticeable seams in some cases. For example, an end part of image data 1 produced by using the seamless texture in a predetermined size does not match an end part of the seamless texture that is disposed in a region including the end part of the image data 1 in some cases. In other words, a middle region of the seamless texture that is disposed in the region including the end part of the image data 1 matches the end part of the image data 1. In such a case, if the same image data 2 is adjacently disposed side by side, a seam between the image data 1 and the image data 2 is not continuous but is noticeable. Specifically, a middle region of the seamless texture in the predetermined size and an end part of the seamless texture in the predetermined size are adjacent to each other at the seam. Furthermore, in a case where large image data that is not divided is produced in advance, a large-capacity memory and a high-performance calculation apparatus are needed and cost increases in some cases. Not only in a case where a plurality of printed materials are arranged but also in a case where one printed material is shaped in a column shape and stereoscopically posted, as well, image continuity is not maintained between adjacent parts in some cases.

Thus, in the present embodiment, control is executed to adjust the size of the seamless texture so that an end part of image data matches an end part of the seamless texture disposed in a region including the end part of the image data.

Accordingly, noticeability of seams due to texture discontinuation between end parts of image data can be reduced. Moreover, since large image data that is not divided does not need to be produced in advance, no large-capacity memory nor high-performance calculation apparatus is needed, and thus high cost can be reduced. In addition, the present embodiment is also applicable to a case where one printed material is shaped in a column shape and stereoscopically posted, and thus noticeability of seams between image data can be reduced also in a case where a stereoscopic product is produced.

### (Printed Material Production Application)

A printed material production application 200 will be described next. The printed material production application 200 is an application program for supporting production and edit of printing image data by the user. The present embodiment describes an example in which the printed material production application 200 is implemented as the Web application 131 that operates on the Web browser 118 of the client terminal 110, but the present disclosure is not limited to the example. For example, processing may be locally performed by using the printed material production application 200 installed on the client terminal 110.

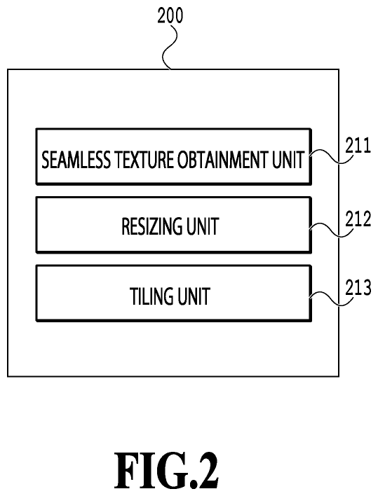

FIG. 2 is a diagram illustrating a functional configuration of the printed material production application 200. As illustrated in the diagram, the printed material production application 200 includes a seamless texture obtainment unit 211, a resizing unit 212, a tiling unit 213, and the like. The printed material production application 200 is an application program that supports production and edit of the original image data for a printed material.

The seamless texture obtainment unit 211 obtains the seamless texture to be used for image data (printing target image) of a printed material. In the present specification, a seamless texture is an image object in a predetermined size unit, which is fabricated to have no seams in a case where arranged side by side. In a case of a pattern (image) with a period, a seamless texture is image data for one period. Note that a seamless texture may be a pattern with periodicity, such as a geometric pattern, or a texture fabricated with no seams from a texture with no particular period. A seamless texture may be, for example, a texture representing natural and artificial materials such as wood grain, stone patterns, and leather.

A seamless texture is continuously drawn without seams at an end part that is a boundary of the seamless texture in a case where arranged side by side without gaps. In a case where a seamless texture is a pattern with periodicity, the seamless texture is drawn so that a plurality of periods are continuous. Disposition side by side without gaps is referred to as tiling in the present specification.

In the present embodiment, a seamless texture can be designated by the user. The seamless texture obtainment unit 211 receives a designation operation on an edit screen to be described later. The seamless texture obtainment unit 211 obtains the seamless texture designated by the user from the program execution server 141.

The resizing unit (the adjustment unit) 212 resizes (adjusts) the seamless texture obtained by the seamless texture obtainment unit 211 so that, in a case where tiled (disposed) in a predetermined region (hereinafter referred to as a disposition region) in image data as a printing target, the seamless texture is continuous without seams between end parts of the disposition region and in an adjacent region that is adjacent to the end part.

In a case of a poster, for example, the image data as a printing target includes both a main content (foreground) of the poster and a background constituted by a seamless texture. In a case where a poster board is assumed as a printing media, the size of the image data as a printing target is equal to the size of the poster board. Note that the first embodiment describes an example in which image data including both a content image and a seamless texture is disposed on the entire surface of the poster board. In other words, the following description assumes that the size of the disposition region is equal to the size of the printing media. However, the present invention is not limited to the example, but the disposition region may be set to a region smaller than the size of the printing media. This example will be described in a second embodiment.

In a case where a seamless texture is a pattern with periodicity, the resizing unit 212 resizes the seamless texture so that the periodicity is maintained between an end part of the disposition region and an adjacent region that is adjacent to the end part. The adjacent region is a region that contacts the disposition region at the above-described end part in a case where a plurality of printed materials on which image data is printed are posted side by side, in a case where one printed material on which image data is printed is posted in a column shape, or by folding.

An end part of a region in which a seamless texture is disposed is at least an end part in an arrangement direction in a case where printed materials are posted. In a case where printed materials are posted side by side in the horizontal direction, the seamless texture is resized so that there are no seams between an end part of the disposition region in the horizontal direction, in other words, a right or left end and the seamless texture disposed to the left or right. In a case where printed materials are posted side by side in the vertical direction, the seamless texture is resized so that there are no seams between an end part of the disposition region in the vertical direction, in other words, an upper or lower end and the seamless texture disposed above or below.

The resizing unit 212 adjusts the size of a seamless texture so that a size scaled to an integral multiple of the size of the seamless texture matches the size of the disposition region. The adjustment is performed for the width size in a case where the arrangement direction is the horizontal direction, is performed for the height size in a case where the arrangement direction is the vertical direction, or is performed for the width size and the height size in a case where the arrangement direction is both the vertical and horizontal directions. A specific resizing method will be described later.

Note that the first embodiment describes an example in which the region in which a seamless texture is disposed is a background region in a printing image. In other words, the seamless texture is disposed in the entire region of printing image data. The first embodiment also describes a case where the arrangement direction in a case where printed materials are posted is the horizontal direction.

The tiling unit (the disposition unit) 213 tiles (dispose) the seamless texture resized by the resizing unit 212 in the disposition region. The tiling unit 213 draws a result of the tiling.

Note that whether to seamlessly dispose the background is switchable by a user operation in examples described in the first embodiment. In addition, the arrangement direction at posting and the size of the disposition region (background) can be set by a user operation. The client terminal 110 displays an edit screen 300 and receives a user operation on the edit screen 300.

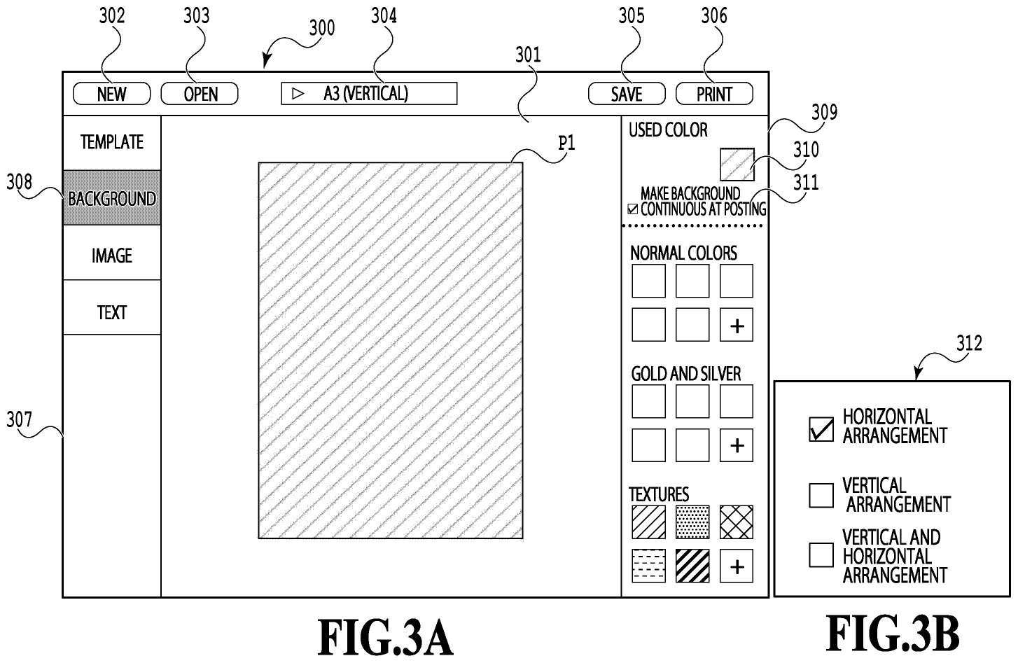

FIGS. 3A and 3B are diagrams illustrating an example of the edit screen 300 of the printed material production application 200. The edit screen 300 includes a preview area 301, a new production button 302, an open button 303, a printed material selection button 304, a save button 305, a print button 306, an object kind selection area 307, an object selection area 309, a checkbox 311, and the like. FIGS. 3A and 3B illustrate a state in which a preview of poster data P1 that is image data being currently edited is displayed in the preview area 301.

The new production button 302 is a button that is operated in a case where the poster data P1 is to be newly produced, and the new poster data P1 is displayed in the preview area 301 and can be edited if the new production button 302 is operated. The open button 303 is a button that is operated in a case where existing edit data (poster data) is to be opened, and a screen for selecting existing poster data is opened if the open button 303 is operated.

The printed material selection button 304 is a button that is operated in a case where the kind, size, and template of a printed material to be produced are to be set, and a screen for setting the kind, size, and template of a printed material is opened if the printed material selection button 304 is operated. On this screen, for example, a poster, a flyer, a tabletop POP, and a brochure are displayed as selectable as the kind of a printed material. After either kind of a printed material is selected, size setting and template selection are further received.

A template is image data in which an object to be used for each subject, the disposition region of the object, folding positions, and the like are designated in advance. Examples thereof include templates of an unfolding diagram of a printed material (quadrilateral POP) that is stereoscopically shaped into a quadrilateral prism, an unfolding diagram of a printed material that is stereoscopically shaped into a triangular prism, an unfolding diagram of a printed material that is stereoscopically shaped into a cylindrical shape, and a folded brochure. Folding positions and adhesive regions are set in advance in these templates of printed materials that are stereoscopically shaped.

The save button 305 is a button that is operated in a case where poster data (edit data) being edited is to be stored, and poster data being edited is stored in a local folder of the client terminal 110 or the storage server 142 if the save button 305 is operated. The print button 306 is a button that is operated in a case where poster data being edited is to be printed. If the print button 306 is operated, the printed material production application 200 activates the printing execution application 119 and receives printing settings such as printing quantity and printing quality. Then, a printing image is generated based on the printing settings and the poster data and transmitted as the printing data 153 to the designated printer 115, and printing is executed.

The object kind selection area 307 is a region in which the kind of an object to be added to the poster data P1 being edited is selected and a template, a background, an image, a text, and the like can be selected. In FIGS. 3A and 3B, “background” of a button 308 is selected. In a case where “background” is selected, the entire region of the poster data P1 being edited is set as the background region. Specifically, the poster width is the width of the background region, and the poster height is the height of the background region.

The object selection area 309 displays the content of an object of the kind selected in the object kind selection area 307. In the example illustrated in FIGS. 3A and 3B, “background” is selected as the kind of an object, and thus a background object list held by the Web application 131 is displayed as selectable. For example, normal colors, gold and silver, and textures are displayed as selectable as background objects. A thumbnail 310 is a thumbnail image of a background object disposed on the poster data P1 being currently edited.

The checkbox 311 is an operation unit for the user to switch whether to make the background continuous seamlessly (without seams) in a case where printed materials on which the poster data P1 is printed are posted side by side. The checkbox 311 receives a check input in a case where a texture is designated as a background object.

In a case where a check is input to the checkbox 311, texture resizing is executed so that seams are not generated at both end parts of the poster data P1 being edited in the arrangement direction. In a case where no check is input to the checkbox 311, texture resizing is not executed. Note that the checkbox 311 may be configured to be activated to receive a check input only in a case where a texture is used as the background and to be deactivated in a case where no texture is used as the background.

In a case where a printed material that can be posted such as a poster or a flyer is an edit target, a selection field for selecting the arrangement direction at posting may be provided on the edit screen 300.

FIG. 3B is a diagram illustrating an example of a selection field 312 for selecting the arrangement direction at posting. In the selection field 312, any one of horizontal arrangement, vertical arrangement, and vertical and horizontal arrangement can be selected. In the present embodiment, horizontal arrangement is selected as an example. The selection field 312 may be configured to be displayed in a case where a check is input to the checkbox 311 or may be configured to be displayed in a case where a poster is selected as an edit target by the printed material selection button 304.

On the edit screen 300 illustrated in FIGS. 3A and 3B, a poster is selected as an edit target, a poster size is set, and a texture (object other than colors) is selected as a background object. In a case where a check is input to the checkbox 311 to make the background seamlessly continuous, the CPU 111 performs tiling processing to be described later on the selected texture.

### (Tiling Processing)

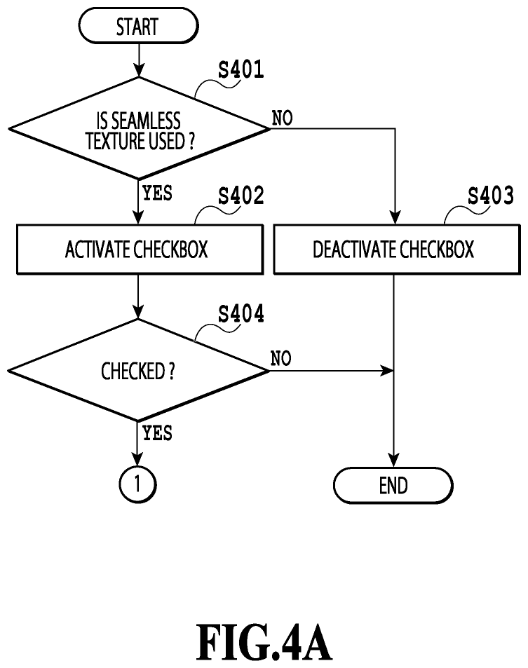

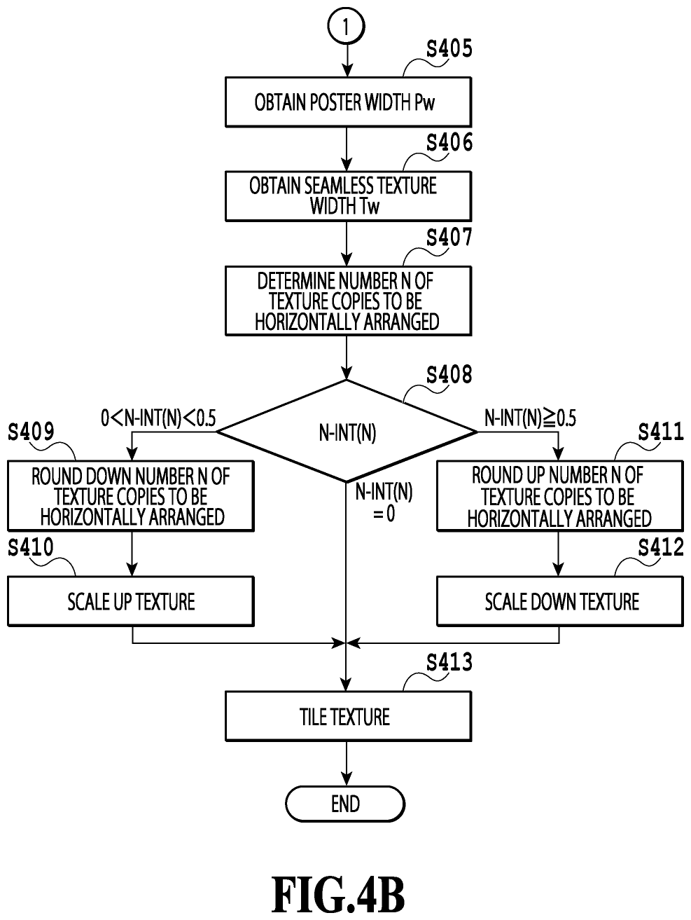

Seamless texture tiling processing will be described next with reference to FIGS. 4A and 4B.

FIGS. 4A and 4B are flowcharts illustrating the process of the tiling processing. FIG. 4A illustrates processing related to seamless texture use setting, and FIG. 4B illustrates processing following FIG. 4A. The processing illustrated in the present flowchart is part of processing at the printed material production application 200 executed between the client terminal 110 and the program execution server 141. The present flowchart is started in a case where the edit screen 300 is displayed on the client terminal 110, a printed material as an edit target is selected by the user, and a background object is selected or a template is newly selected.

In the following description, symbol “S” means step. Processing at each step is processing of the client program 121 and executed by the CPU 111 of the client terminal 110 in the following description, but may be processing of the server program 151. In a case where processing at each step is processing of the server program 151, the processing is executed by the CPU of the program execution server 141. Note that processing request, response, and data transmission-reception performed between the server 141 and the client terminal 110 are omitted in description.

At S401, the CPU 111 determines whether a seamless texture is used as the background of the poster data P1 being edited. The CPU 111 determines whether a seamless texture is used based on the attributes of a background object being selected, which is indicated by the thumbnail 310. Each background object is provided with attribute information indicating an object type. By referring to the attribute information, the CPU 111 can determine whether the background object being selected is a texture (texture other than gold and silver), a color (including a fluorescence color), or a gold-silver texture.

In a case where the background object being selected is a texture, it is determined that a seamless texture is used (YES at S401), and the process proceeds to S402. In a case where the background object being selected is a color or a fluorescence color, it is determined that no seamless texture is used (NO at S401), and the process proceeds to S403.

At S402, the CPU 111 activates the checkbox 311. As described above, the checkbox 311 is an input field for switching whether to make the background at both ends of a poster continuous without seams. In a case of activated, the checkbox 311 receives a check input by the user.

At S403, the CPU 111 deactivates the checkbox 311 by non-display or by control to prevent inputting of a check.

At S404, the CPU 111 determines whether a check is input to the checkbox 311.

The process proceeds to S405 in a case where a check is input (YES at S404), or ends the present flowchart in a case where a check is not input (NO at S404).

Processing of making the background seamlessly continuous at both ends of a poster will be described below.

At S405, the CPU 111 obtains a width (poster width) Pw of the poster data P1 being edited. In the example illustrated in FIGS. 3A and 3B, “A3 (vertical)” size is selected with the printed material selection button 304. Accordingly, the poster width Pw is 297 mm.

At S406, the CPU 111 obtains a width Tw of the seamless texture. For example, the width Tw of the seamless texture is 10 mm in a case where the size of the seamless texture is 10 mm×10 mm.

At S407, the CPU 111 determines, based on the poster width Pw obtained at S405 and the width Tw of the seamless texture obtained at S406, a number N of copies of the seamless texture in a case where horizontally arranged in the poster width Pw. In the example illustrated in FIGS. 3A and 3B, since the poster width Pw is 297 mm and the width Tw of the seamless texture is 10 mm, the number N of texture copies in the horizontal direction is 297/10=29.7.

At S408, the CPU 111 branches subsequent processing in accordance with the decimal point value (N−INT(N)) of the number N of copies in a case where the seamless texture is horizontally arranged. In a case where the decimal point value is larger than 0 and smaller than 0.5 (0<N−INT(N)<0.5), the process proceeds to S409. In a case where the decimal point value is equal to or larger than 0.5 (N−INT(N)≥0.5), the process proceeds to S411. In a case where the decimal point value is zero (N−INT(N)=0), in other words, in a case where the number N of copies is an integer, the process proceeds to S413.

At S409, the CPU 111 rounds down the number N of texture copies to be horizontally arranged. The number of texture copies after the rounding-down is represented by N′ (N′ is an integer value).

At S410, the CPU 111 scales up the seamless texture to exactly match the poster width Pw in a case where N′ copies are arranged in the horizontal direction.

At S411, the CPU 111 rounds up the number N of texture copies to be horizontally arranged. The number of texture copies after the rounding-up is represented by N′.

At S412, the CPU 111 scales down the seamless texture to exactly match the poster width Pw in a case where N′ copies are arranged in the horizontal direction.

In the example illustrated in FIGS. 3A and 3B, the number N of texture copies in the horizontal direction is 29.7, and thus at S408, the decimal point value is determined to be equal to or larger than 0.5, and the process proceeds to S411. At S411, 29.7 is rounded up and the number N′ of texture copies to be horizontally arranged is determined to be 30. Since the poster width Pw is 297 mm and the number N′ of texture copies to be horizontally arranged is 30, the size of the seamless texture is scaled down to 9.9 mm×9.9 mm based on the calculation result of 297 mm/30 copies=9.9 [mm/copy] at S412.

Thus, the size of the seamless texture is adjusted so that an end part of the poster width and an end part of the seamless texture disposed in a region including the end part of the poster width satisfy a predetermined condition. Specifically, the predetermined condition is that an end part of the poster width matches an end part of the seamless texture disposed in a region including the end part of the poster width. In a case where image data as a printing target is disposed side by side in a predetermined disposition region, the predetermined condition is that the seamless texture is continuous between end parts of the disposition region and an end part of an adjacent region that is adjacent to the end part of the disposition region.

At S413, the CPU 111 tiles the resized seamless texture in the background region of the poster data P1. A result of the tiling is drawn in the preview area 301. Note that processing at S413 is performed without scaling up nor down in a case where a value (number N) obtained by dividing the poster width Pw by the width Tw of the seamless texture is an integer.

The size of the seamless texture and the poster size are exemplary and may be optional values. Moreover, the method of calculating the number of copies of the seamless texture to be arranged in the horizontal direction is not limited to the above-described example. For example, in the above-described flowchart, the number N′ of arranged copies of the seamless texture is determined in accordance with the decimal point value of the quotient N of the poster width Pw and the width Tw of the seamless texture, but the present invention is not limited to this calculation method. For example, in a case where the quotient N is not an integer, the value N may be rounded up or down in a single uniform manner to determine the integer value N′.

The CPU 111 executes processing at S401 to S413 each time a background object is selected (changed) by the user. Accordingly, the background of the poster data P1 being edited is switched in accordance with an operation by the user, and the background is drawn so that no seams are generated at the right and left ends of the poster data P1. For example, in a case where a pattern (texture) with periodicity is selected as a background object, the background is drawn so that the periodicity of the background is maintained between end parts of printing data (printed material) such as a poster. Accordingly, in a case where a plurality of printed materials are arranged, the background is continuous between adjacent printed materials and seams become unnoticeable.

According to the above-described embodiment, printing image data can be produced so that seams are unnoticeable in a case where a plurality of printed materials such as posters are posted side by side. This improves convenience in a case where a plurality of pieces of image data are arranged to produce image data.

Specifically, in a case where a texture is selected as the background by the user, continuity of the background is instructed, and the arrangement direction at posting is designated, the CPU 111 resizes the texture so that a value scaled to an integral multiple of the width of the texture matches the poster width, and then tiles the texture. As a result, the seamless texture (background) with which an end part of the poster matches an end part of the texture can be drawn. Thus, in a case where a plurality of posters are horizontally posted, the continuity of the texture is maintained at parts where the posters contact each other so that the posters can appear as one large poster without seams.

Moreover, according to the above-described embodiment, posting without seams is possible not only in a case where a plurality of printed materials are posted side by side but also in a case where one printed material is stereoscopically posted with right and left ends connected.

Note that although a case where posters are horizontally arranged is described above in the embodiment, the size of the seamless texture is adjusted by the same method also in a case where posters are vertically arranged or in a case where posters are vertically and horizontally arranged.

In the case of vertical arrangement, the CPU 111 obtains a poster height Ph in place of the poster width Pw, obtains a height Th of the seamless texture in place of the width Tw of the seamless texture, and determines a number M of texture copies to be arranged in the vertical direction. Then, the seamless texture is resized based on the magnitude of the decimal point value. In a case where the decimal point value of the value M is smaller than 0.5, the texture is scaled up to exactly match the poster height Ph with a rounded-down value M′ (M′ is an integer value). In a case where the decimal point value of the value M is equal to or larger than 0.5, the texture is scaled down to exactly match the poster height Ph with a rounded-up value M′. In a case where M is an integer value, tiling is performed without resizing.

In the case of vertical and horizontal arrangement, the seamless texture is resized in the horizontal and vertical directions before tiling. For example, in a case where the poster size is selected to be A3 (vertical) size, the poster width Pw is 297 mm and the poster height Ph is 420 mm. In a case where the seamless texture of 10 mm×10 mm is arranged, the number N of texture copies to be horizontally arranged is calculated to be 29.7 and the number M of texture copies to be vertically arranged is calculated to be 42. In this case, resizing is not performed in the vertical direction since the integer value is obtained, and resizing is performed only in the horizontal direction to scale the size of the seamless texture down to 9.9 mm×10 mm.

Note that in the example described above in the embodiment, switching of whether to make the background continuous at both ends of a poster is executed in accordance with a user operation of check inputting to the checkbox 311. However, in place of switching control based on a user operation, the CPU 111 may be configured to automatically switch whether to make the background continuous. Moreover, although a seamless texture is disposed as the background in the above-described example, the present invention is also applicable to a case where a seamless texture is disposed on the foreground instead of the background and a case where a seamless texture is disposed on an intermediate layer between the background and the foreground.

### Second Embodiment

The second embodiment will be described next. The first embodiment above describes an example in which a seamless texture is resized so that the continuity of the background is maintained between adjacent posters in a case where a plurality of printed materials (posters) are posted side by side. The second embodiment describes an example in which a seamless texture is resized so that in a case where parts of a single printed material at end parts of the background region are brought into contact, the continuity of the background is maintained between the end parts.

As an example, a case where image data of a printed material to be stereoscopically posted is produced by using the printed material production application 200 described above in the first embodiment will be described below. A case where an unfolding diagram of a tabletop POP shaped in a cylindrical or quadrilateral prism is produced as an example of a printed material to be stereoscopically posted will be described. Note that processing in the second embodiment is also applicable to a case where a seamless texture is disposed in a partial region of one printed material, a case of a folded brochure, and the like.

The configuration of an information processing system 1 and the configuration of an edit screen of a Web application (printed material production application 200) in the second embodiment are the same as in the first embodiment, and thus duplicate description thereof is omitted and differences will be described below.

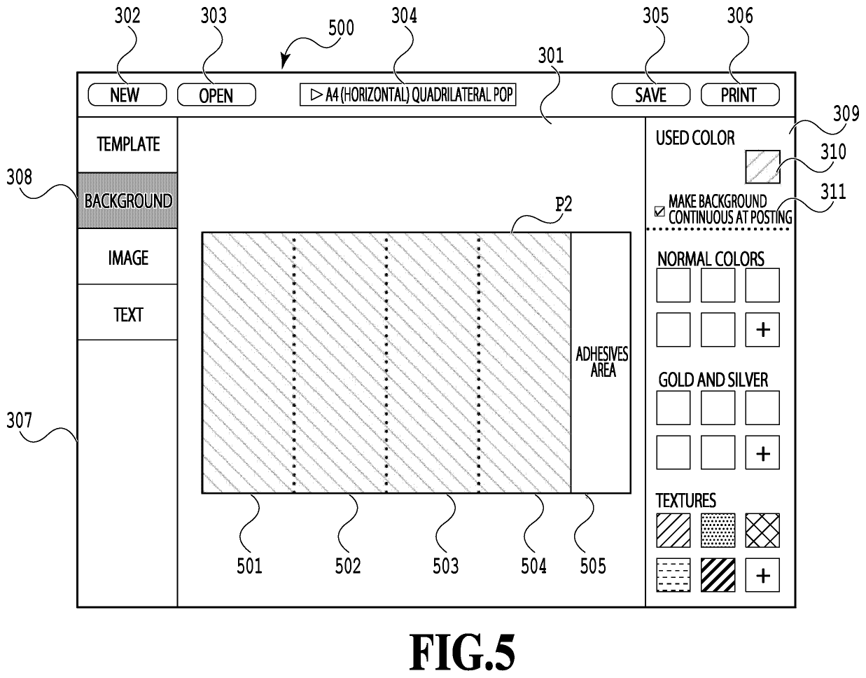

FIG. 5 is a diagram illustrating an example of an edit screen 500 of the printed material production application in the second embodiment. The example illustrated in FIG. 5 is a state in which “A4 (horizontal) quadrilateral POP” is selected with the printed material selection button 304 and a corresponding template P2 is displayed as an edit target in a preview area 101.

The template P2 is one of templates corresponding to “A4 (horizontal) quadrilateral POP” and is image data indicating an unfolding diagram of a printed material to be shaped in a quadrilateral prism shape after printing. Data of templates of various printed materials, including the template P2 is stored as data of the printed material production application 200 in the storage server 142 or the like in advance.

The template P2 is provided in advance with areas 501, 502, 503, 504 in which various objects such as a background, an image, and a text can be disposed, and an adhesive area 505 for overlapping and gluing at shaping. A quadrilateral prism is shaped if an unfolding diagram on which image data indicated by the template P2 is printed is folded at the boundaries between the areas and the adhesive area 505 is overlapped with the area 501. In this case, the left end of the area 501 contacts the right end of the area 504.

If a template is selected with the printed material selection button 304 on the edit screen 500 (FIG. 5) of the printed material production application 200, a request for transmission of the template is transmitted from the client program 121 to the server program 151. In response to the request, the server program 151 calls the corresponding template and transmits the template to the client program 121.

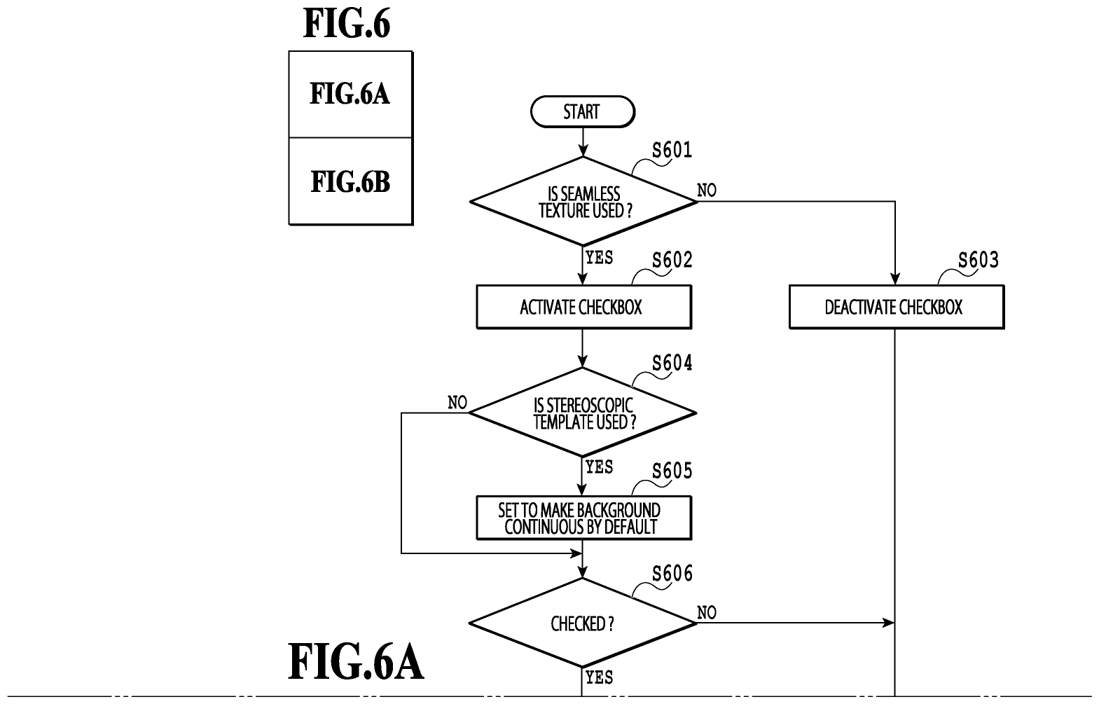

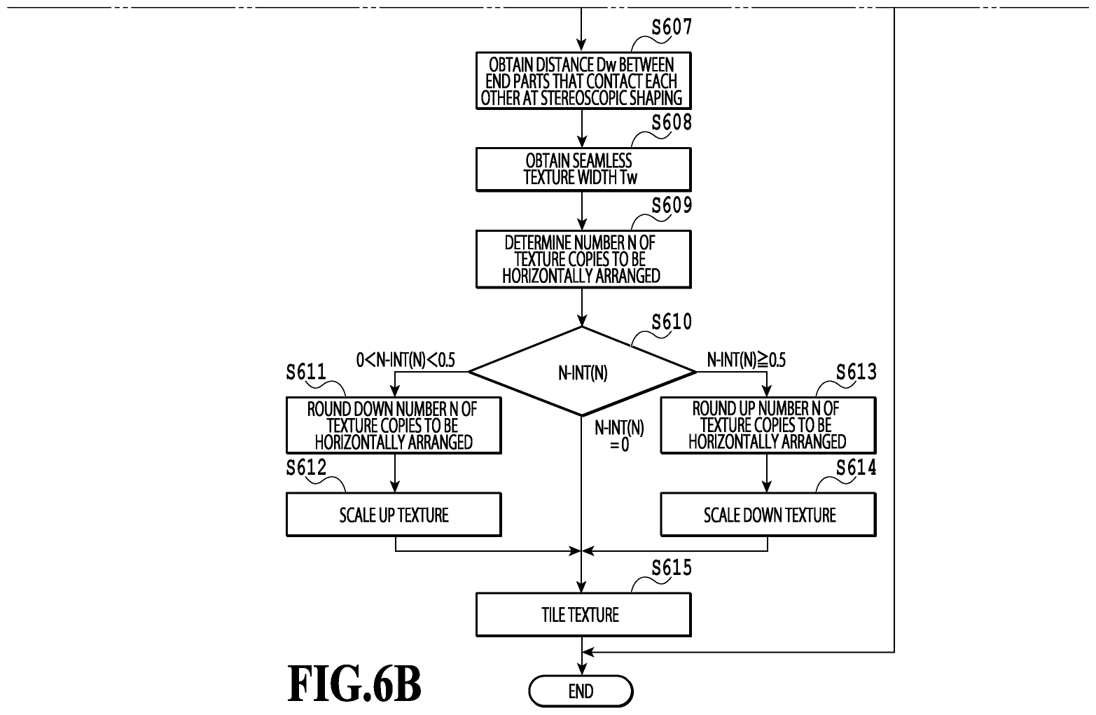

FIG. 6 is a flowchart illustrating the process of tiling processing in the second embodiment. The processing illustrated in the present flowchart is started in a case where the printed material production application 200 is executed, the edit screen 500 is displayed on the client terminal 110, and a template, a size, and a background object is selected by the user.

At S601, the CPU 111 determines whether a seamless texture is used in a region as the background of the template P2 (unfolding diagram of a quadrilateral POP) being edited. The CPU 111 determines whether a seamless texture is used by referring to attribute information of the background object being selected, which is indicated by the thumbnail 310.

In a case where the background object being selected is a texture, it is determined that a seamless texture is used as the background (YES at S601), and the process proceeds to S602. In a case where the background object being selected is a color or a fluorescence color, it is determined that no seamless texture is used (NO at S601), and the process proceeds to S603.

At S602, the CPU 111 activates the checkbox 311 and receives a check input by the user.

At S603, the CPU 111 deactivates the checkbox 311 by control to prevent inputting of a check.

At S604, the CPU 111 determines whether a stereoscopic template is used for a printed material being edited. In a case where a stereoscopic template is used (YES at S604), the process proceeds to S605. In a case where no stereoscopic template is used (NO at S604), the process proceeds to S606.

At S605, the CPU 111 sets by default to make a region as the background of the printed material seamlessly continuous. Specifically, even if the user does not perform a check input to the checkbox 311, the CPU 111 checks the checkbox 311 and sets to make the background continuous. Note that, in a case where no stereoscopic template is used, S605 is skipped and whether to make the background continuous is set in accordance with existence of an input to the checkbox 311 by a user operation.

At S606, the CPU 111 determines whether a check is input to the checkbox 311. The process proceeds to S607 in a case where a check is input (YES at S606), or ends the present flowchart in a case where a check is not input (NO at S606).

The following describes a case where it is set to make the background continuous at both ends of a region in which the background of the template P2 is disposed.

At S607, the CPU 111 obtains a distance Dw between end parts that contact each other at stereoscopic shaping. For example, in the case of a “quadrilateral POP” in FIG. 5, the left hand side of the area 501 and the right hand side of the area 504 contact each other in the state of being stereoscopically shaped. Since the disposition region of the background is set over the areas 501, 502, 503, and 504 in the template P2, the background needs to be continuous in the horizontal direction. Accordingly, the above-described distance Dw is the distance between the left hand side of the area 501 and the right hand side of the area 504. Note that, in the case of the template P2, the distance Dw is also the distance along the outer periphery of a stereoscopic object.

Since the size of the template is A4 (horizontal), the entire width of the printed material P2 is 297 mm. In a case where the width of the adhesive area 505 is set to 3 mm, the distance Dw from the left hand side of the area 501 to the right hand side of the area 504 is 297−3=294 mm.

At S608, the CPU 111 obtains the width Tw of the seamless texture. For example, in the example illustrated in FIG. 5, the width Tw of the seamless texture is 10 mm in a case where the size of the seamless texture is 10 mm×10 mm.

At S609, the CPU 111 determines, based on the distance Dw obtained at S607 and the width Tw of the seamless texture, which is obtained at S608, the number N of copies in a case where the seamless texture is horizontally arranged. For example, since the distance Dw is 294 mm and the width Tw of the seamless texture is 10 mm, the number N of texture copies in the horizontal direction is 294/10=29.4.

At S610, the CPU 111 branches subsequent processing in accordance with the decimal point value (N−INT(N)) of the number N of copies in a case where the seamless texture is horizontally arranged. As in the first embodiment, the process proceeds to S611 in a case where the decimal point value is larger than 0 and smaller than 0.5 (0<N−INT(N)<0.5), or the process proceeds to S613 in a case where the decimal point value is equal to or larger than 0.5 (N−INT(N)≥0.5). In a case where the decimal point value is zero (N−INT(N)=0), in other words, in a case where the number N of copies is an integer, the process proceeds to S615.

At S611, the CPU 111 rounds down the number N of texture copies to be horizontally arranged. The number of texture copies after the rounding-down is represented by N′. Subsequently at S612, the CPU 111 scales up the seamless texture to exactly match the distance Dw in a case where N′ copies of the texture are arranged in the horizontal direction.

In the example illustrated in FIG. 5, since the number N of texture copies in the horizontal direction is 29.4, the decimal point value is determined to be smaller than 0.5 at S610, and the process proceeds to S611. At S611, 29.4 is rounded down and the number N′ of texture copies to be horizontally arranged is determined to be 29. Since the distance Dw from the left hand side of the area 501 to the right hand side of the area 504 is 294 mm and the number N′ of texture copies to be horizontally arranged is 29, 294 mm/29 copies=10.137 . . . [mm/copy] is calculated at S612. From this calculation result, the size of the seamless texture is scaled up to 10.14 mm×10.14 mm.

At S613, the CPU 111 rounds up the number N of texture copies to be horizontally arranged. The number of texture copies after the rounding-up is represented by N′. Subsequently at S614, the CPU 111 scales down the seamless texture to exactly match the distance Dw in a case where N′ copies of the texture are arranged in the horizontal direction.

At S615, the CPU 111 tiles the seamless texture in the areas 501 to 504 of the template P2. A result of the tiling is drawn in the preview area 301. Note that processing at S615 is performed without scaling up nor down in a case where a value (number N) obtained by dividing the distance Dw by the width Tw of the seamless texture is an integer.

The size of the seamless texture and the template size are exemplary and may be optional values. Moreover, the method of calculating the number of copies of the seamless texture to be arranged in the horizontal direction is not limited to the above-described method. The CPU 111 executes processing at S601 to S615 each time a background object is selected by the user. Accordingly, drawing of a region in which the background of the template P2 being edited is disposed is switched in accordance with an operation by the user, and the background is drawn so that no seams are generated after stereoscopic shaping.

As described above, in the second embodiment, the disposition region of a seamless texture is a partial region of a printed material that is stereoscopically posted. The client terminal 110 obtains the distance Dw between end parts that contact each other in the state of being stereoscopically shaped, resizes the seamless texture in accordance with the distance Dw before tiling.

Accordingly, the background can be continuously drawn without seams between the contacting end parts in a case where the printed material is stereoscopically posted. Moreover, in the second embodiment, switching is performed to make the background continuous by default in a case where a stereoscopic template (unfolding diagram of a stereoscopic object) is an edit target and a texture is selected as the background, and thus the user does not need to perform a switching operation.

### Modification

In the example illustrated in FIG. 5, the background region in the template P2 is set in advance to a region that is the side surface of a stereoscopic object in a case where a printed material is stereoscopically shaped, but as a modification, the background may be disposed in an optional region designated by the user. Specifically, an optional area among the areas 501 to 504 of the template P2 may be designated as the disposition region of the background by the user.

In a case where two or more areas that become adjacent to each other at stereoscopic shaping are designated as the disposition region of the background and a seamless texture is selected as the background, the CPU 111 switches to continuously draw the background of the areas by default. The CPU 111 resizes the seamless texture in accordance with a distance Ew between an end part of the region in which the background is disposed and one of end parts that contact each other at stereoscopic shaping.

For example, in the template P2 of FIG. 5, only the areas 501 and 504 are designated as the disposition region of the background by the user and a seamless texture is selected. Then, the CPU 111 resizes the seamless texture in accordance with the distance Ew between one of end parts that contact each other at stereoscopic shaping and an end part of the background region. In this example, the distance Ew is the width of the designated areas (areas 501 and 504).

Specifically, in a case where the sizes of the areas 501 and 504 in the width direction are each 73.5 mm and the seamless texture of 10 mm×10 mm is simply tiled in each area, N=73.5/10=7.35 is rounded to N′=7. There is a shortfall of 3.5 mm in a case where seven copies are arranged in the horizontal direction. Thus, 7.35 is rounded down and the size of the seamless texture is resized to exactly match the width of each area in a case where seven copies are arranged in the horizontal direction. The size of the seamless texture is resized to 10.5 mm×10.5 mm based on calculation of 7.35 mm/7 copies=10.5 [mm/copy].

This modification is not limited to a stereoscopic object in a prism shape but is applicable to, for example, a gate-folded brochure. Specifically, a seamless texture is resized and tiled to exactly arrange an integer number of copies in accordance with the distance Ew between one of end parts that contact each other in a case where the folded brochure is closed and a folding position. Accordingly, the seamless texture can be continuously disposed without seams in a case where the brochure is closed.

In the second embodiment and the modification, the arrangement direction of a seamless texture is not limited to the horizontal direction but may be the vertical direction. In this case as well, the size of the seamless texture is adjusted by the same method as in the above description to exactly arrange an integer number of copies in the vertical direction of the disposition region. Resizing in the horizontal direction and resizing in the vertical direction may be combined. Moreover, although a seamless texture is disposed as the background in the above-described example, processing in the present embodiment is also applicable to a case where a seamless texture is disposed on the foreground instead of the background and a case where a seamless texture is disposed on an intermediate layer between the background and the foreground.

### Third Embodiment

A third embodiment will be described next. The third embodiment describes a method of making seams between posters unnoticeable in a case where a texture with gloss expression, such as gold or silver, is selected as the background of a printed material such as a poster. The third embodiment is different from the first embodiment in that, in gloss expression of gold, silver, and the like, a seamless texture that expresses convexo-concave texture of a sheet is synthesized with an illumination pattern that represents surface gloss.

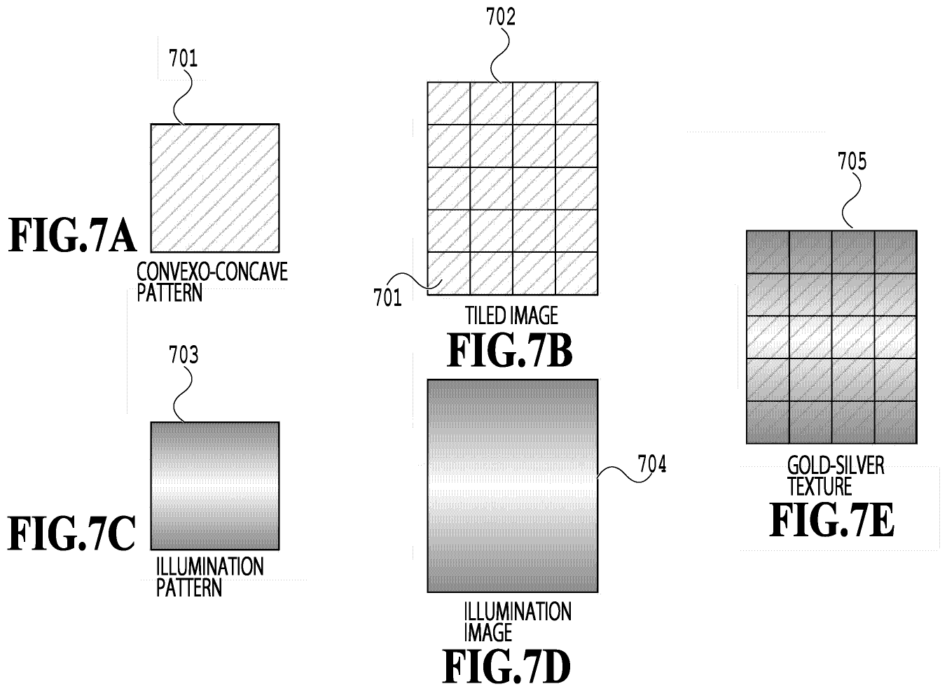

The following description is made with reference to FIGS. 7 to 12. Note that the configuration of the information processing system 1 and the configuration of an edit screen 900 of a Web application (printed material production application 200) in the third embodiment are the same as in the first embodiment, and thus duplicate description thereof is omitted and differences will be described below. In the following description, a texture with gloss expression resembling gold or silver is referred to as a “gold-silver texture”.

FIGS. 7A to 7E are diagrams illustrating an example of a method of generating a gold-silver texture. A gold-silver texture is typically generated by synthesizing (superimposing) a convexo-concave pattern 701 illustrated in FIG. 7A and an illumination pattern 703 illustrated in FIG. 7C. The convexo-concave pattern 701 is a seamless texture that expresses convexo-concave texture on the surface. For example, a minute convexo-concave pattern in a predetermined size or smaller is expressed in the size of 10 mm×10 mm. The illumination pattern 703 is an image that expresses gloss, and is superimposed on the convexo-concave pattern 701.

FIG. 7B illustrates a tiled image 702 in which four copies of the convexo-concave pattern 701 are arranged in the horizontal direction and five copies thereof are arranged in the vertical direction. The tiled image 702 has a size of 40 mm horizontal×50 mm vertical. An image illustrated in FIG. 7D is an illumination image 704 obtained by scaling up the illumination pattern 703 in a predetermined size to the same size as the tiled image 702 illustrated in FIG. 7B. As illustrated in FIG. 7E, a gold-silver texture 705 having a size of 40 mm horizontal×50 mm vertical is generated by superimposing, on the tiled image 702 generated from a plurality of copies of the convexo-concave pattern 701, the illumination image 704 obtained by scaling up the one illumination pattern 703.

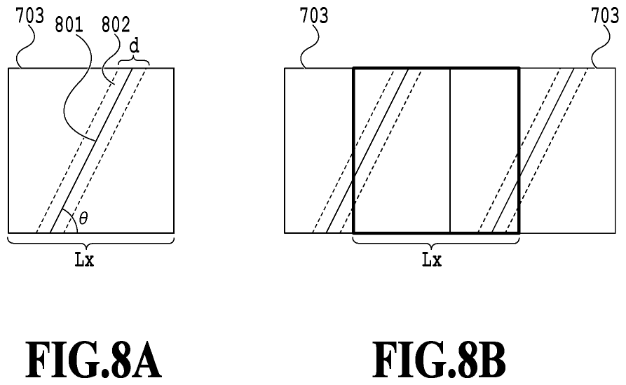

FIG. 8 is a diagram for description of the illumination pattern 703.

As illustrated in FIG. 8A, gloss of the illumination pattern 703 is defined with an angle θ and a width d of a gloss region 802. The gloss angle θ is the angle between the horizontal direction of the diagram and a gloss central line 801. The gloss angle θ is variable in a range in which the gloss region 802 is seamlessly continuous between two adjacent illumination patterns 703 in a case where the illumination patterns 703 are arranged side by side as illustrated in FIG. 8B. For example, in a case where the illumination patterns 703 are disposed side by side in the horizontal direction, θ can take 0° or an arbitrary value in the range of 45° to 135°. The illumination pattern 703 illustrated in FIG. 7C corresponds to an example of θ=0°.

The gloss width d is the width of the gloss region 802. The above-described gloss central line 801 is the central line of the gloss region 802 in the width direction. The gloss width d is determined in a range with which the gloss region 802 is positioned in the illumination pattern 703 based on the angle θ of the gloss central line 801 and a width Lx of the illumination pattern 703.

Note that the gloss angle θ and the gloss width d of the illumination pattern 703 used in the present embodiment are determined by the client program 121 (CPU 111). Details will be described later.

As illustrated in FIG. 8A, the range of the gloss width dis 0≤d≤Lx−Lx/tan θ in a case where the gloss region 802 with the gloss width d is set in the illumination pattern 703. For example, the range of the gloss width d is 0≤d≤10−10/√3 in a case of the gloss angle θ=60° and the width Lx of the illumination pattern=10 mm.

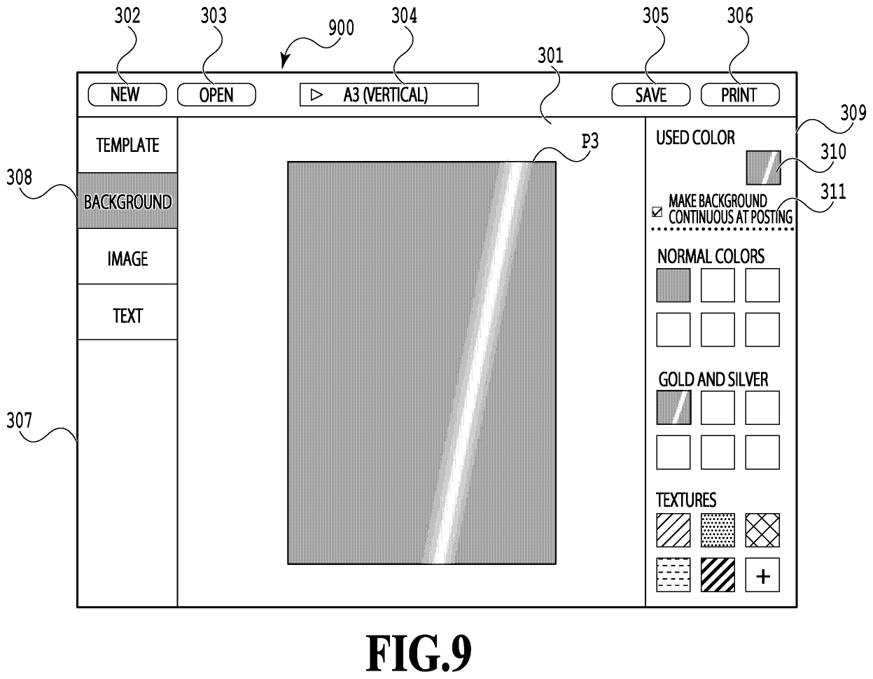

FIG. 9 is a diagram illustrating an example of the edit screen 900 of the printed material production application 200 in the third embodiment. In the present example, “A3 (vertical)” is selected with the printed material selection button 304. In addition, a background 308 is designated in the object kind selection area 307, and a gold-silver texture is designated in the object selection area 309. The thumbnail 310 displays a thumbnail image corresponding to an object selected in the object selection area 309.

A state in which the gold-silver texture selected in the object selection area 309 by the user is seamlessly disposed in the horizontal direction at posting is indicated on the background of poster data P3 displayed in the preview area 301.

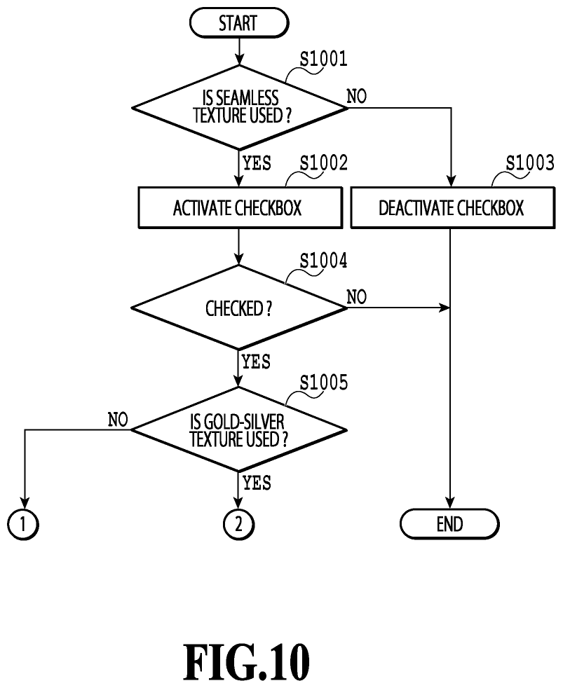

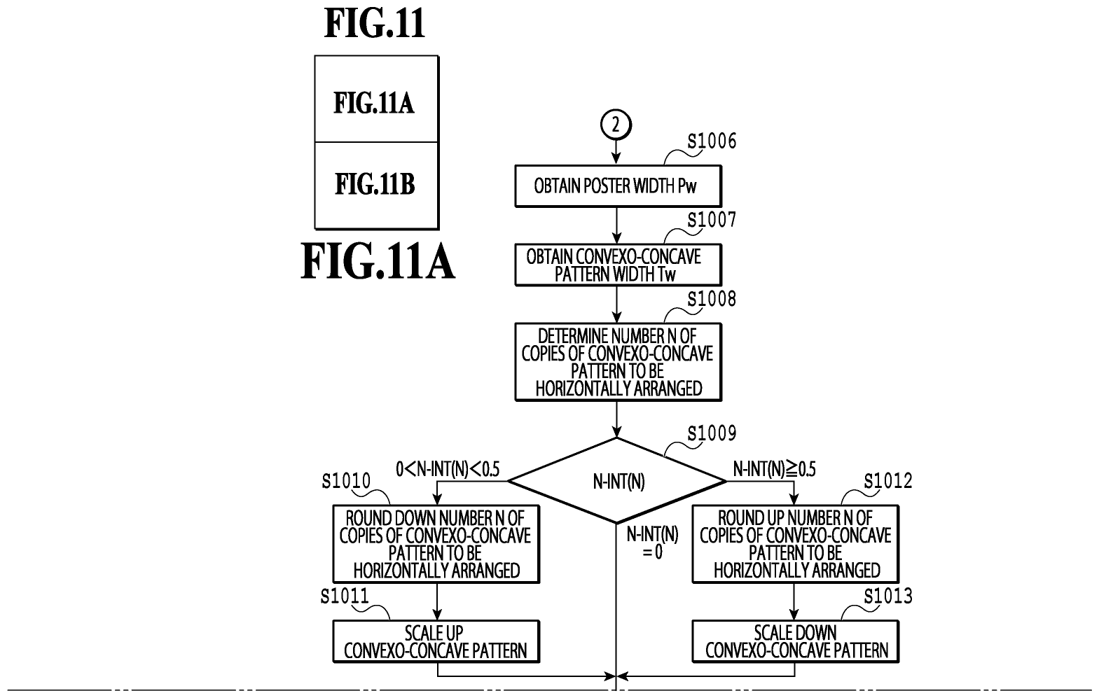

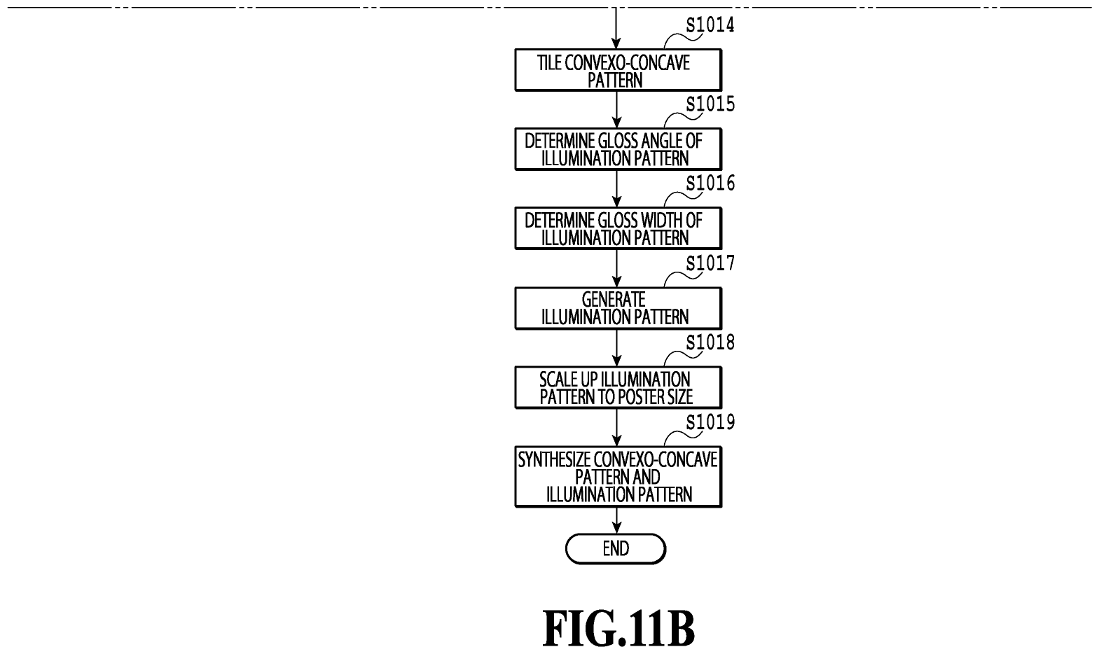

FIGS. 10 and 11 are a flowchart illustrating the process of tiling processing in the third embodiment. The processing illustrated in the present flowchart is started in a case where the above-described printed material production application 200 is executed, the edit screen 900 is displayed on the client terminal 110, and a poster size or a background object is selected or a template is newly selected by the user.

At S1001, the CPU 111 determines whether a seamless texture is used as the background of the poster data P3 being edited. The CPU 111 determines whether a seamless texture is used based on the attributes of a background object being selected, which is indicated by the thumbnail 310. In a case where the background object being selected is a texture or a gold-silver texture, it is determined that a seamless texture is used as the background (YES at S1001), and the process proceeds to S1002. In a case where the background object being selected is a color or a fluorescence color, it is determined that no seamless texture is used (NO at S1001), and the process proceeds to S1003.

At S1002, the CPU 111 activates the checkbox 311 and receives a check input by the user.

At S1003, the CPU 111 deactivates the checkbox 311 by non-display or by control to prevent inputting of a check.

At S1004, the CPU 111 determines whether a check is input to the checkbox 311. The process proceeds to S1005 in a case where a check is input (YES at S1004), or ends the present flowchart in a case where a check is not input (NO at S1004).

At S1005, the CPU 111 determines whether the texture used as the background is a gold-silver texture. In a case where the texture used as the background is not a gold-silver texture (NO at S1005), the process proceeds to S405 in FIG. 4B and executes processing at S405 to S413 as in the first embodiment. Description of S405 to S413 is omitted. At S1005, in a case where it is determined that the texture used as the background is a gold-silver texture (YES at S1005), the process proceeds to S1006 in FIG. 11.

The following describes processing of making the background seamlessly continuous at both ends of the poster data P3 in a case where a gold-silver texture is used as the background of the poster data P3.

At S1006, the CPU 111 obtains the width (poster width) Pw of the poster data P3 being edited. In the example illustrated in FIG. 9, “A3 (vertical)” size is selected with the printed material selection button 304. Accordingly, the poster width Pw is 297 mm.

At S1007, the CPU 111 obtains the width Tw of the convexo-concave pattern 701 that is a seamless texture included in the gold-silver texture. The width Tw of the convexo-concave pattern 701 is 10 mm in a case where the size of the convexo-concave pattern 701 is 10 mm×10 mm.

At S1008, the CPU 111 determines the number N of copies in a case where the convexo-concave pattern 701 is horizontally arranged in the poster width Pw based on the poster width Pw obtained at $1006 and the width Tw of the convexo-concave pattern 701, which is obtained at S1007. In the example illustrated in FIG. 9, since the poster width Pw is 297 mm and the width Tw of the convexo-concave pattern 701 is 10 mm, the number N of copies of the convexo-concave pattern 701 in the horizontal direction is 297/10=29.7.

At S1009, the CPU 111 branches subsequent processing in accordance with the decimal point value (N−INT(N)) of the number N of copies in a case where the convexo-concave pattern 701 is horizontally arranged. The process proceeds to S1010 in a case where the decimal point value is larger than 0 and smaller than 0.5 (0<N−INT(N)<0.5). The process proceeds to S1012 in a case where the decimal point value is equal to or larger than 0.5 (N−INT(N)≥0.5). The process proceeds to S1014 in a case where the decimal point value is zero (N−INT(N)=0), in other words, in a case where the number N of copies is an integer.

At S1010, the CPU 111 rounds down the number N of horizontally arranged copies of the convexo-concave pattern 701. The number of copies after the rounding-down is N′.

At S1011, the CPU 111 scales up the convexo-concave pattern 701 to exactly match the poster width Pw in a case where N′ copies of the convexo-concave pattern 701 are arranged in the horizontal direction.

At S1012, the CPU 111 rounds up the number N of horizontally arranged copies of the convexo-concave pattern 701. The number of copies after the rounding-up is N′.

At S1013, the CPU 111 scales down the convexo-concave pattern 701 to exactly match the poster width Pw in a case where N′ copies of the convexo-concave pattern 701 are arranged in the horizontal direction.

For example, since the number N of horizontally arranged copies of the convexo-concave pattern 701 is 29.7 in the example illustrated in FIG. 9, the decimal point value is determined to be equal to or larger than 0.5 at S1009, and the process proceeds to S1012. At S1012, 29.7 is rounded up and N′ is determined to be 30. Since the poster width Pw is 297 mm and the number N′ of horizontally arranged copies is 30, the size of the convexo-concave pattern 701 is scaled down to 9.9 mm×9.9 mm based on the calculation result of 297 mm/30 copies=9.9 [mm/copy] at S1013.

Note that the size of the convexo-concave pattern 701 and the poster size are exemplary and may be optional values. Moreover, the method of calculating the number of copies of the convexo-concave pattern 701 to be arranged in the horizontal direction is not limited to the above-described example.

At S1014, the CPU 111 generates the tiled image 702 by tiling the resized convexo-concave pattern 701 in the background region of the poster data P3 as illustrated in FIG. 7B. The tiled image 702 is drawn in the preview area 301. Note that processing at S1014 is performed without scaling up nor down in a case where a value (number N) obtained by dividing the poster width Pw by the width Tw of the convexo-concave pattern 701 is an integer.

At S1015, the CPU 111 determines the gloss angle θ of the illumination pattern 703. For example, θ is determined to be 60°. As described above, the angle θ can take 0° or an arbitrary value in the range of 45° to 135° in the case of horizontal arrangement.

At S1016, the CPU 111 determines the gloss width d of the illumination pattern 703. The gloss width d is, for example, 1 mm. As described above, the gloss width d is determined in accordance with the gloss angle θ and the width Lx of the illumination pattern 703. Note that the gloss width d is not limited to this value but can take an arbitrary value in the range of d=0 to 10−10/√3 mm in a case where θ is 60° and the width Lx of the illumination pattern 703 is 10 mm.

At S1017, the CPU 111 generates the illumination pattern 703 including the gloss region 802 with the gloss width d=1 mm and the angle θ=60°. Then, the generated illumination pattern 703 is horizontally arranged as illustrated in FIG. 8B and cut out at optional positions. Through processing at S1017, the seamless illumination pattern 703 is generated in the horizontal direction, and the position of the gloss region 802 can be set to an optional position in the above-described range.

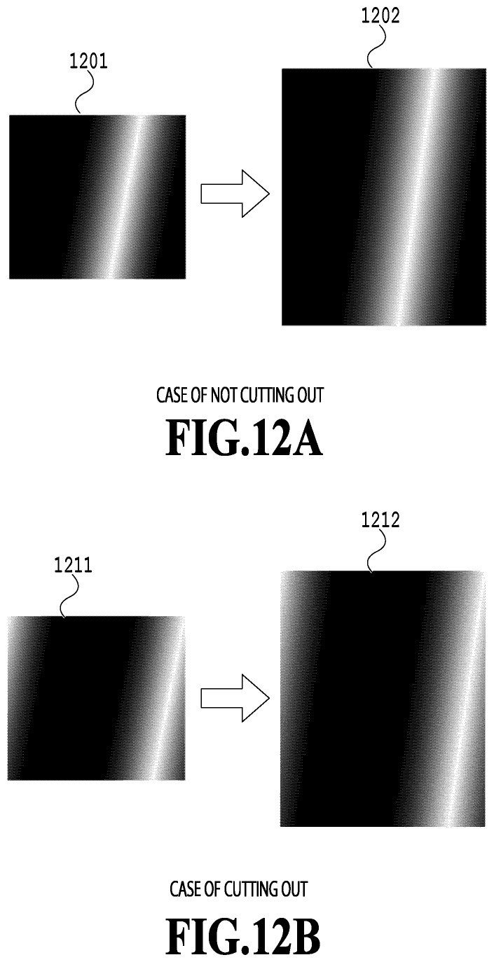

FIGS. 12A and 12B are diagrams illustrating difference between the illumination pattern 703 in a case where the cutout processing is not performed and the illumination pattern 703 in a case where the cutout processing is performed. In FIGS. 12A and 12B, images on the left side illustrate illumination patterns 1201 and 1211, respectively, in a unit size, and images 1202 and 1212 on the right side are images obtained by scaling up the illumination patterns 1201 and 1211 in the unit size, which are illustrated on the left side, to a desired size.

In a case where processing at S1017 is not performed, the gloss region is expressed within one sheet as illustrated in FIG. 12A. In a case where processing at S1017 is performed, the gloss region can be disposed across an end part as illustrated in FIG. 12B. Gloss that is continuous between adjacent posters in a case where printed materials are horizontally posted can be expressed.

At S1018, the CPU 111 scales up the illumination pattern 703 in the unit size, which is generated at S1017, to the size of the poster data P3. Accordingly, the illumination image 704 as illustrated in FIG. 7D is generated. Note that the aspect ratio of the illumination pattern 703 changes through scaling-up in some cases, which is however not a problem because the continuity of the gloss region between end parts is maintained.

At S1019, the CPU 111 generates the gold-silver texture 705 with the poster size by synthesizing the tiled image 702, which is obtained by tiling a plurality of resized convexo-concave patterns 701 in a region with the poster size, and one scaled-up illumination pattern (illumination image 704). The generated gold-silver texture 705 is illustrated in FIG. 7E.

The CPU 111 executes processing at S1001 to S1019 each time a background object is selected (changed) by the user. Accordingly, the background of the poster data P3 being edited is switched in accordance with an operation by the user, and the background is drawn without seams at the right and left ends of the poster data P1. In a gold-silver texture, the gloss region can be expressed without seams between end parts of a poster (printed material), and thus seamless glossiness can be expressed between adjacent printed materials in a case where a plurality of printed materials are arranged.

Note that although a case where posters are horizontally arranged is described above in the example, the size of a gold-silver texture can be adjusted by the same method in a case of vertical arrangement. However, unlike the above-described example, the range of the gloss angle θ can take an arbitrary value in the ranges of 0°≤θ≤45° and 45≤°θ≤135°.

As described above, in the third embodiment, as in the first embodiment, printing image data can be produced for a gold-silver texture, as well, such that in a case where a plurality of printed materials such as posters are posted side by side, seams of the background are unnoticeable at end parts of the printed materials in the arrangement direction. In particular, gloss expression can be expressed without seams between adjacent printed materials, and thus the printed materials can appear as one large printed material. Posting without seams is possible not only in a case where a plurality of printed materials are posted side by side but also in a case where one printed material is stereoscopically posted with the right and left ends connected.

The second and third embodiments may be combined. Specifically, in a case where a region as the background is partial like a template described in the second embodiment, a gold-silver texture can be disposed on the background by combining processing in the third embodiment.

An example in which a gold-silver texture is generated by synthesizing the convexo-concave pattern 701 stored in advance and the illumination pattern 703 generated by the CPU 111 is described above in the third embodiment, but generation of a gold-silver texture is not limited to this method. Instead of processing of generating the illumination pattern 703, which is illustrated at S1015 to S1017 in FIG. 11, for example, a plurality of illumination patterns 703 that are seamless in the horizontal direction may be prepared (stored) in advance and subjected to selection by the user. In this case as well, the same effects as in the above-described example can be obtained by scaling up a selected illumination pattern 703 to a poster size and superimposing the scaled illumination pattern 703 on the tiled image 702 of the convexo-concave pattern 701.

The third embodiment is applicable not only to a gold-silver texture but also to a texture obtained by synthesizing (superimposing) a first pattern that is a seamless texture and a second pattern that is an image object in a predetermined size.

Specifically, the CPU 111 obtains the first pattern as a seamless texture, adjusts the size of the first pattern so that the first pattern is continuous without seams between end parts of the region in a case where arranged side by side in a predetermined region, and generates a tiled image by tiling the first pattern. In addition, the second pattern that is an image object in a predetermined size is obtained, the size of the second pattern is adjusted to the size of the region, and the adjusted second pattern is superimposed on the region in which the first pattern is arranged side by side.

Accordingly, seams between printed materials can be made unnoticeable in expression that surface texture is added by using the second pattern in the region in which the first pattern is seamlessly drawn.

Although the embodiments according to the present disclosure are described above with reference to the accompanying drawings, the present disclosure is not limited to such examples. It is clear that various changed examples or modified examples could be thought of by the skilled person in the art within the scope of the technical idea disclosed in the present application, and it should be understood that these examples belong to the technical scope of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-158109, filed Sep. 22, 2023, which is hereby incorporated by reference wherein in its entirety.

What is claimed is:

1. An information processing apparatus comprising:
an obtainment unit configured to obtain a seamless texture that is an image object in a predetermined size unit;
an adjustment unit configured to adjust the size of the seamless texture so that the seamless texture is continuous between an end part of a predetermined disposition region of image data as a printing target and an end part of an adjacent region that is adjacent to the end part in a case where the seamless texture is arranged side by side in the disposition region; and
a disposition unit configured to dispose the seamless texture adjusted by the adjustment unit side by side in the disposition region.

2. The information processing apparatus according to claim 1, wherein in a case where the seamless texture is a pattern with a period, the adjustment unit adjusts the size of the seamless texture so that the period of the pattern is maintained between an end part of the disposition region and an adjacent region that is adjacent to the end part in a case where the seamless texture is arranged side by side in the disposition region.

3. The information processing apparatus according to claim 1, wherein the end part is an end part in an arrangement direction in a case where a printed material on which the image data is printed is posted.

4. The information processing apparatus according to claim 1, wherein the disposition region is a region including entirety from one end to the other end of a printed material in a case where the image data is printed.

5. The information processing apparatus according to claim 1, wherein the disposition region is a partial region of a printed material on which the image data is printed.

6. The information processing apparatus according to claim 1, further comprising a switching unit configured to switch whether to perform the adjustment by the adjustment unit.

7. The information processing apparatus according to claim 6, wherein the switching unit switches whether to perform the adjustment by the adjustment unit in accordance with an operation by a user.

8. The information processing apparatus according to claim 6, wherein the switching unit switches whether to perform the adjustment by the adjustment unit in accordance with the kind of the image data.

9. The information processing apparatus according to claim 1, further comprising a first reception unit configured to receive the size of a printed material or selection of a template.

10. The information processing apparatus according to claim 9, wherein the adjustment by the adjustment unit is performed in a case where a stereoscopic shaping template is selected by the first reception unit.

11. The information processing apparatus according to claim 3, further comprising a second reception unit configured to receive selection of the arrangement direction.

12. The information processing apparatus according to claim 1, wherein the adjustment unit adjusts the size of the seamless texture so that a size scaled to an integral multiple of the size of the seamless texture matches the size of the disposition region.

13. The information processing apparatus according to claim 1, wherein
the obtainment unit obtains a first pattern as the seamless texture,
the adjustment unit adjusts the size of the first pattern so that the seamless texture is continuous between an end part of the disposition region and an adjacent region that is adjacent to the end part in a case where the first pattern is arranged side by side in the disposition region,
the disposition unit arranges the adjusted first pattern side by side in the disposition region, and
the information processing apparatus further includes
a second obtainment unit configured to obtain a second pattern that is an image object of a predetermined size,
a second adjustment unit configured to adjust the size of the second pattern obtained by the second obtainment unit to the size of the disposition region, and
a superimposition unit configured to superimpose the second pattern adjusted by the second adjustment unit onto the disposition region in which the adjusted first pattern is arranged side by side.

14. The information processing apparatus according to claim 13, wherein
the first pattern is an convexo-concave pattern that represents surface convexo-concave, and
the second pattern is an illumination pattern as an image that represents gloss.

15. The information processing apparatus according to claim 14, further comprising a generation unit configured to generate the illumination pattern so that the gloss is continuous in an arrangement direction in a case where a printed material on which the image data is printed is posted.

16. The information processing apparatus according to claim 3, wherein the arrangement direction is a horizontal direction or a vertical direction.

17. The information processing apparatus according to claim 3, wherein the arrangement direction is both a horizontal direction and a vertical direction.

18. The information processing apparatus according to claim 1, further comprising a display unit configured to display the image data with the seamless texture arranged in the disposition region by the disposition unit, wherein
each time the seamless texture disposed in the disposition region is changed by a user, the obtainment of the seamless texture by the obtainment unit, the adjustment of the size of the seamless texture by the adjustment unit, and the disposition by the disposition unit are executed and the display of the image data by the display unit is changed.

19. An information processing method executed by a computer, the information processing method comprising:
obtaining a seamless texture that is an image object in a predetermined size unit;
adjusting the size of the seamless texture so that the seamless texture is continuous between an end part of a predetermined disposition region of image data as a printing target and an end part of an adjacent region that is adjacent to the end part in a case where the seamless texture is disposed side by side in the disposition region; and
disposing the adjusted seamless texture side by side in the disposition region.

20. A non-transitory computer readable storage medium storing a program which causes a computer to execute an information processing method comprising:
obtaining a seamless texture that is an image object in a predetermined size unit;
adjusting the size of the seamless texture so that the seamless texture is continuous between an end part of a predetermined disposition region of image data as a printing target and an end part of an adjacent region that is adjacent to the end part in a case where the seamless texture is disposed side by side in the disposition region; and
disposing the adjusted seamless texture side by side in the disposition region.
